(19) United States
(12) Patent Application Publication
(10) Pub. No.: US 2011/0148615 A1
(43) Pub. Date: Jun. 23, 2011

(54) Method for Determining at Least One Operating State of a Hybrid Vehicle and a Hybrid Vehicle

(75) Inventors: Uwe SEITZ, Muenchen (DE); Andreas Penka, Muenchen (DE); Mathis Bode, Muenchen (DE); Nicolas Schreiber, Landshut (DE)

(73) Assignee: Bayerische Motoren Werke Aktiengesellschaft, Muenchen (DE)

(21) Appl. No.: 13/006,651

(22) Filed: Jan. 14, 2011

Related U.S. Application Data
(63) Continuation of application No. PCT/EP2009/004729, filed on Jul. 1, 2009.

(30) Foreign Application Priority Data
Jul. 16, 2008 (DE) 10 2008 033 481.2

(51) Int. Cl. G06F 7/00; B60Q 1/00

(52) U.S. Cl. 340/439; 701/35; 701/29; 903/903

(57) ABSTRACT

A method determines at least one operating state of a hybrid vehicle, wherein the at least one operating state is determined by way of at least one time duration. Furthermore, a hybrid vehicle is provided which has a unit for implementing the method.

### CROSS-REFERENCE TO RELATED APPLICATIONS

This application is a continuation of PCT International Application No. PCT/EP2009/004729, filed Jul. 1, 2009, which claims priority under 35 U.S.C. §119 from German Patent Application No. DE 10 2008 033 481.2, filed Jul. 16, 2008, the entire disclosures of which are herein expressly incorporated by reference.

### BACKGROUND AND SUMMARY OF THE INVENTION

The invention relates to a method for determining at least one operating state of a hybrid vehicle, and to a hybrid vehicle.

A hybrid vehicle utilizes, in particular, two different drive concepts for a driving task. Electric motors and Otto or diesel engines, for example, can be used in one vehicle.

The individual motors of a hybrid drive can be operated in parallel and simultaneously act upon the vehicle or upon components connected with the vehicle. As an alternative, the motor can be operated in a serial manner. In that case, only one drive acts directly upon the vehicle, while the other drive provides power which, in a converted state, is fed to the directly acting drive. Mixed types are also available.

Ideally, a user of the vehicle is not very aware of these possible operating modes during the drive. The hybrid vehicle preferably decides itself which operating mode it chooses and switches (almost) imperceptibly between the operating modes. However, in this case, the user lacks any comparison possibility with a conventional vehicle that utilizes only a combustion engine. This is a disadvantage because the user also wants to be informed of the different operating modes and the resulting efficiency of his hybrid vehicle.

It is therefore an object of the invention to avoid the above-mentioned disadvantages and especially to provide a possibility for the efficient determination and utilization of operating modes of a hybrid vehicle. Conclusions can be drawn or measures can be derived therefrom with respect to an economical or consumption-optimized operation of the hybrid vehicle.

This and other objects are achieved by a method for determining at least one operating state of a hybrid vehicle, wherein the at least one operating state is determined for at least one time duration.

The operating state is especially an operating state of at least one drive of the hybrid vehicle and/or an operating state associated with at least one drive of the hybrid vehicle.

Since the at least one operating state is determined for a predefined time duration, conclusions can be drawn concerning the efficiency of the hybrid vehicle, particularly with respect to its use and/or surroundings (driving profile, area of use, traffic density, etc.)

It is a further development that the at least one operating state is determined by way of the at least one time duration by means of a cumulation and/or averaging of several measured values. In particular, the measured values may originate from the vehicle or from at least one drive of the vehicle or may be associated therewith.

It represents a further development that at least two operating states are determined and are related to one another for the at least one time duration.

In particular, it is a further development that the at least one time duration comprises several time intervals, the at least one operating state being determined for each time interval.

More particularly, several operating states can be determined in an absolute manner or in a manner comparable relative to one another and can be acknowledged or displayed. Based on such data, conclusions can be drawn concerning operating points of the vehicle.

It is also a further development that the time intervals can be predefined or set.

In particular, also the at least one time duration can be implemented to be adjustable and/or configurable.

The operating points to be determined as well as the time duration of the time intervals can be implemented to be configurable. A user can, for example, carry out a configuration by way of a man-machine interface of the hybrid vehicle.

In addition, it represents a further development that the at least one operating state comprises at least one of the following operating states:

(a) an electric operating state of the hybrid vehicle,

(b) one operating state of the hybrid vehicle with an active internal-combustion engine, preferably only one combustion engine being active,

(c) a mixed operating state of the hybrid vehicle.

Within the scope of an additional further development, a predefinable action is carried out by way of the at least one operating state. A predefinable action is, for example, the changing of the operating points of a hybrid vehicle or the operating of the drives with an adapted characteristic curve.

A next further development consists of the fact that the at least one operating state is acknowledged and/or displayed for the at least one time duration. Particularly, an information unit of the hybrid vehicle, such as a video screen or a display, can be used for such a representation.

It is a further development that an advantageous driving method of the hybrid vehicle is determined by way of at least one operating state.

An alternative embodiment consists of the fact that a desired-actual comparison is made with at least one stored operating state by way of the at least one operating state.

The above-mentioned object is also achieved by way of a hybrid vehicle comprising a processor unit and/or an at least partially hardwired or logic circuit arrangement which is set up such that the method can be carried out as discussed above.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a chart view of a percentage of a first and a percentage of a second operating state of a hybrid vehicle, a distribution of the percentages being preferably determined for a defined time duration Δt;

FIG. 2 is a chart view of percentages of three operating states of the hybrid vehicle for a time duration Δt;

FIG. 3 is a chart view of an example in which percentages of three operating states corresponding to FIG. 2 are continuously determined for one time duration Δt respectively; and

FIG. 4 is a block diagram of an arrangement for processing and/or determining defined operating states.

### DETAILED DESCRIPTION OF THE DRAWINGS

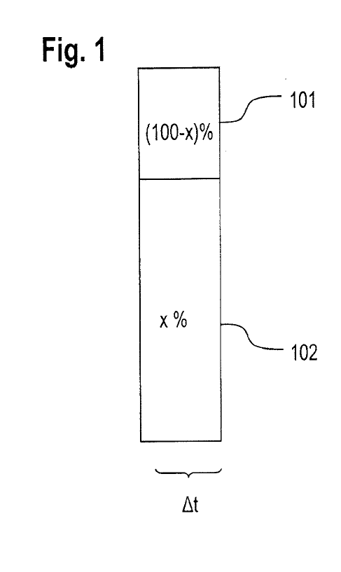

FIG. 1 illustrates a first operating state 101 and a second operating state 102 of a hybrid vehicle in which case, for example, the first operating state 101 is an electric operating state with a percentage of (100-x) %, and the second operating state 102 is an operating state with an active combustion engine with a percentage of x %.

The distribution of the percentages is preferably determined for a defined time duration (period of time) Δt which can be configured by a user by way of a man-machine interface.

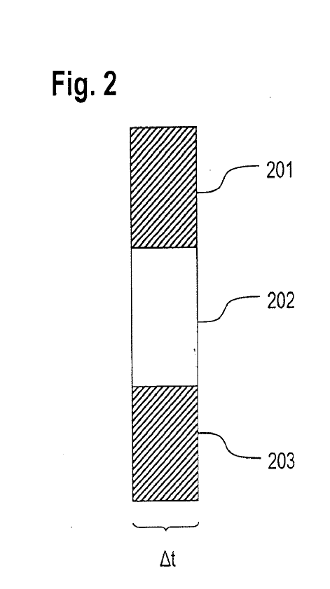

For the purpose of comparison, FIG. 2 illustrates percentages of three operating states 201, 202 and 203 of the hybrid vehicle for a time duration of Δt. As an example, the operating state 201 is an electric operating state of the hybrid vehicle, and the operating state 203 is an operating state in which particularly only the combustion engine is driving the vehicle. The operating state 202 may be a mixed operation with a partially active electric motor or a partially active combustion engine. Correspondingly, a plurality of conceivable (additional) operating states can be determined or displayed.

Together, the respective percentages of the operating states may be standardized to 100%. As an alternative, an absolute value (for example, an energy consumption standardized to a comparable amount, such as liters per 100 km) can be determined and displayed also for at least one operating state.

The determined quantities and operating states can preferably be shown on a display, which can easily be seen or read by a user of the vehicle and/or by passengers of the vehicle.

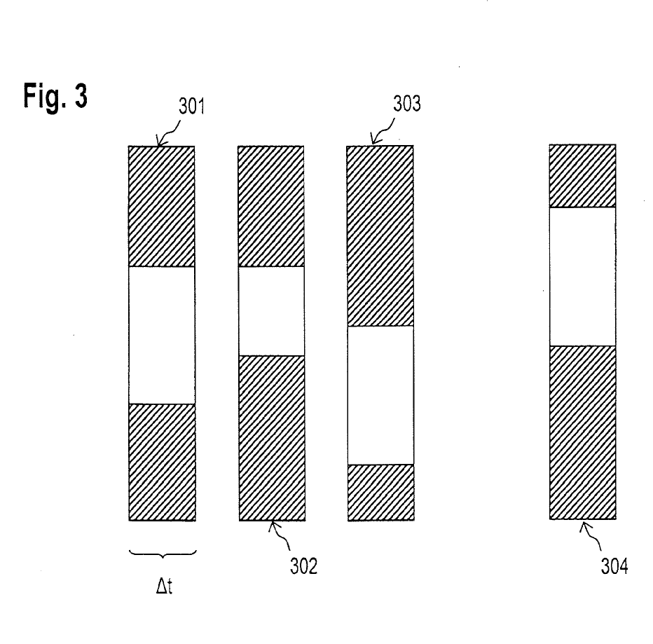

FIG. 3 shows an example wherein percentages of three operating states corresponding to FIG. 2 are continuously determined (views 301 to 304) for one time duration Δt respectively. The time duration Δt can preferably be adjusted or configured by the user. FIG. 3 illustrates as an example that the percentages of the operating states vary over the course of time. This permits comparisons concerning the use of the hybrid vehicle, particularly with respect to certain routes and/or driving profiles. In particular, it becomes possible to achieve an improved utilization of the hybrid vehicle by use of the data determined and evaluated in this manner.

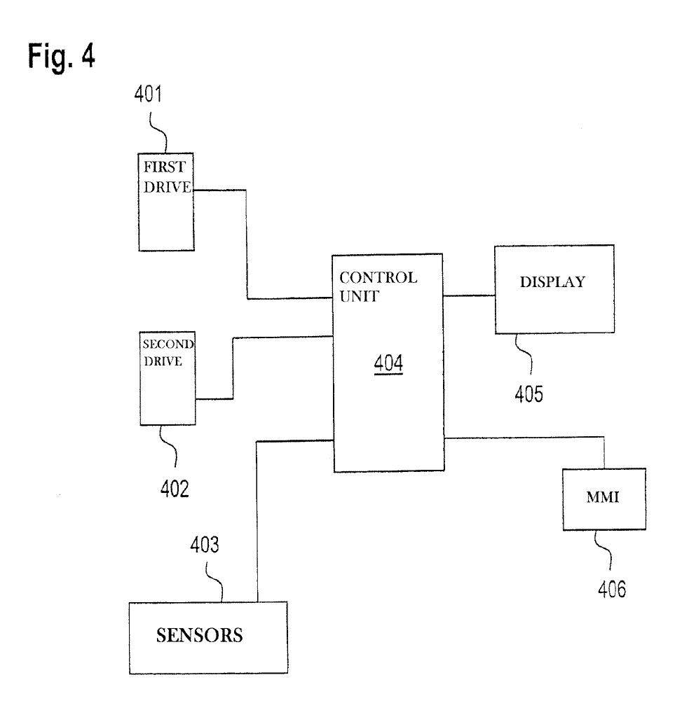

FIG. 4 illustrates an arrangement for the processing and/or for the determination of certain operating states. For example, a first drive 401 and a second device 402, such as an electric motor and a combustion engine, respectively, are provided from which data or states can be retrieved or determined preferably by way of a control unit 404. By means of the data retrieved by the control unit, possibly while taking into account additional data originating from other information sources or sensors 403 of the hybrid vehicle, the percentages and/or energy consumptions of certain operating states are determined per time duration Δt. In this case, any combination of a mixed operation can be determined by use of the data or operating states retrieved from the drives 401, 402 as well as from the other information sources or sensors 403 of the hybrid vehicle. Correspondingly, for example, a distribution can be determined for two (see FIG. 1) or for three (see FIG. 2 and FIG. 3) operating states and can be displayed on a display 405 of the hybrid vehicle. The control unit 404 can be configured by way of a man-machine interface 406. Thus, for example, operating states can be selected and/or a time duration Δt can be set. Furthermore, it becomes possible to select or configure the type of the representation on the display 405 by use of the man-machine interface 406. Possibilities for storing or for comparing given data, routes or profiles can also be offered to the user. A selection can correspondingly take place by way of the man-machine interface 406.

Furthermore, the control unit 404 can be set up such that, as a function of determined data or operating states, or as a function of distributions of operating states over time, an efficient adjustment is carried out in the hybrid vehicle. In particular, the drives 401, 402 can be at least partially adjusted or selected corresponding to the determined values.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining at least one operating state of a hybrid vehicle, the method comprising the acts of:
retrieving data concerning operating states of the hybrid vehicle; and
determining the at least one operating state over at least one period of time.

2. The method according to claim 1, wherein the act of determining the at least one operating state over the one period of time is carried out by at least one of an accumulation and an averaging of several measured values associated with the hybrid vehicle.

3. The method according to claim 1, wherein the determining act determines at least two operating states of the hybrid vehicle, said two operating states being related to one another over the one period of time.

4. The method according to claim 2, wherein the determining act determines at least two operating states of the hybrid vehicle, said two operating states being related to one another over the one period of time.

5. The method according to claim 1, wherein the one period of time comprises several time intervals, said at least one operating state being determined for each time interval.

6. The method according to claim 3, wherein the one period of time comprises several time intervals, said at least one operating state being determined for each time interval.

7. The method according to claim 5, wherein said several time intervals are predefinable or settable.

8. The method according to claim 6, wherein said several time intervals are predefinable or settable.

9. The method according to claim 1, wherein the at least one operating state comprises at least one of:
an electric operating state of the hybrid vehicle,
one operating state of the hybrid vehicle with an active combustion engine, and
a mixed operating state of the hybrid vehicle.

10. The method according to claim 2, wherein the at least one operating state comprises at least one of:
an electric operating state of the hybrid vehicle,
one operating state of the hybrid vehicle with an active combustion engine, and
a mixed operating state of the hybrid vehicle.

11. The method according to claim 3, wherein the at least one operating state comprises at least one of:
an electric operating state of the hybrid vehicle,
one operating state of the hybrid vehicle with an active combustion engine, and
a mixed operating state of the hybrid vehicle.

12. The method according to claim 1, further comprising the act of:
carrying out a predefinable action using the at least one operating state.

13. The method according to claim 1, further comprising the act of:
at least one of acknowledging and displaying the at least one operating state for the one period of time.

14. The method according to claim 2, further comprising the act of:
at least one of acknowledging and displaying the at least one operating state for the one period of time.

15. The method according to claim 3, further comprising the act of:
at least one of acknowledging and displaying the at least one operating state for the one period of time.

16. The method according to claim 5, further comprising the act of:
at least one of acknowledging and displaying the at least one operating state for the one period of time.

17. The method according to claim 1, further comprising the act of:
determining an advantageous driving method of the hybrid vehicle by using the at least one operating state.

18. The method according to claim 1, further comprising the act of:
comparing the determined at least one operating state with at least one stored operating state of the hybrid vehicle.

19. A hybrid vehicle, comprising:
at least one of a processor and a partially hardwired or logic circuit arrangement;
wherein said at least one of the processor and the partially hardwired or logic circuit arrangement is operatively configured to receive data on operating states of the hybrid vehicle and to determine at least one operating state over at least one period of time.

20. The hybrid vehicle according to claim 19, further comprising a display by which the determined at least one operating state is recognizable by a user of the hybrid vehicle.
